(19) United States
(12) Patent Application Publication
(10) Pub. No.: US 2024/0330649 A1
(43) Pub. Date: Oct. 3, 2024

(54) INFERENCE METHOD EMPLOYING PROMPT-BASED META-LEARNING NETWORK AND COMPUTER SYSTEM

(71) Applicant: Electronics and Telecommunications Research Institute, Daejeon (KR)

(72) Inventors: Jeongmin YANG, Daejeon (KR); Hyun Woo KIM, Daejeon (KR); Hwajeon SONG, Daejeon (KR); Byunghyun YOO, Daejeon (KR); Euisok CHUNG, Daejeon (KR); Ran HAN, Daejeon (KR)

(73) Assignee: Electronics and Telecommunications Research Institute, Daejeon (KR)

(21) Appl. No.: 18/610,804

(22) Filed: Mar. 20, 2024

(30) Foreign Application Priority Data
Mar. 30, 2023 (KR) 10-2023-0041865

(51) Int. Cl. G06N 3/043

(52) U.S. Cl. CPC G06N 3/043

(57) ABSTRACT

Provided is an inference method employing a prompt-based meta-learning network and a computer system. The inference method includes selecting a task, generating a prompt key for the selected task using a prompt-embedding network (PEN), calculating similarities between the prompt key for the selected task and prompt keys included in a prompt key pool (PKP), acquiring a prompt value for the selected task using a memory network (MN), and generating an inference result for the selected task using a model-agnostic meta-learning (MAML)-based pre-trained model (MPM).

### CROSS-REFERENCE TO RELATED APPLICATION

This application claims priority to and the benefit of Korean Patent Application No. 10-2023-0041865, filed on Mar. 30, 2023, the disclosure of which is incorporated herein by reference in its entirety.

### BACKGROUND

### 1. Field of the Invention

The present invention relates to a meta-learning and inference method in the field of artificial intelligence (AI), and more particularly, to a meta-learning and inference method with which the range of processible tasks is expanded by increasing the speed of adapting to new tasks while maintaining generalization performance.

### 2. Discussion of Related Art

### 1. Meta-Learning and Meta-Reinforcement Learning

Meta-learning is the field of research aimed at applying the human brain's ability to solve problems by quickly adapting to new tasks which are not encountered during a training phase to machine learning, and is known as a technique for “learning how to learn.” Existing deep learning networks have made rapid progress across all the areas of supervised learning, non-supervised learning, and reinforcement learning, but regardless of application fields, existing deep learning networks have consistently shown poor performance on data not used for training. Particularly, in reinforcement learning, it is common for a network trained to solve a specific task to fail to solve the task when the task changes even slightly, requiring the network to be retrained from the beginning. For example, a deep reinforcement learning network that has learned how to escape a maze with predetermined entrance and exit locations will fail to solve the problem or show a dramatic drop in performance when the entrance or exit location changes slightly.

Prior to the advent of the common name “meta-learning,” localized solutions to the problem described above (poor performance on data or tasks not encountered during training) were devised for each application field. In this regard, few-shot learning, zero-shot learning, and the like are known in the field of image classification. For reference, few-shot learning is an area for improving image classification performance using only a very limited number of datasets in the training phase, and zero-shot learning is an area for classifying images not encountered in the training phase. Both are fields of research for increasing data efficiency and convergence speed. Transfer learning is also an area of research that grew out of a similar problem, and is a technique for reducing the convergence time of a learning process by only adding a fine-tuning process when a network trained on one task is applied to another task.

Meta-learning includes any methodology that improves performance on datasets or tasks not used in the training phase. As shown in FIG. 1 (source: https://research.samsung.com/blog/Meta-Learning-in-Neural-Networks), meta-learning involves a different/superior/meta-algorithm or deep learning network that assists an existing deep learning network. Meta-learning is classified into optimization-based meta-learning, metric-based meta-learning, and model-based meta-learning, and the like according to the approach to problem solving.

One famous paper in the field of optimization-based meta-learning, MAML (Chelsea Finn et al., “Model-Agnostic Meta-Learning for Fast Adaptation of Deep Networks,” 2017) emphasizes that the most obvious way to “learn how to learn” is to find an optimal initial point for a deep learning network, and presents an iterative methodology to find an initial point with the highest generalization performance (i.e., an initial point that may converge the network through the fewest training steps) for solving new tasks. MAML involves nested loops. First, in an inner loop, a usual deep learning process is performed to calculate the gradient of a loss function of each task and update weights for each task. In an outer loop, the gradient of the sum of the gradients of task-specific loss functions is calculated to derive an initial point for the network to be used in the next iteration.

While optimization-based meta-learning focuses on reducing learning time (or convergence time), metric-based meta-learning aims to learn metrics for representing data not seen in the training phase in terms of positions and distances in appropriate dimensions. The few-shot and zero-shot learning described above may also be processed through metric-based meta-learning and are also related to representation learning. Model-based meta-learning is a method of rapidly training an existing network using an external network or memory and is performed by storing information, data, and hyperparameters of previously learned tasks.

Meta-learning is also applied to reinforcement learning, addressing the shortcomings of existing reinforcement learning in which performance on tasks not encountered during training degrades. The foregoing three approaches (the optimization-based approach, metric-based approach, and model-based approach) are all effective for meta-reinforcement learning, and due to the characteristics of reinforcement learning, the model-based approach and the metric-based approach are used in combination. One of such approaches, context-based meta-reinforcement learning, aims at increasing convergence speed in a new task using the relationship between a previous task and the new task. The model-based approach is used to store previous tasks (or trajectories), and the metric-based approach is used to employ correlations between tasks. To improve the generalization performance of meta-reinforcement learning, a task augmentation method employing a generative model or interpolation between several tasks may be used.

### 2. Prompt Learning (=In-Context Learning)

Natural language processing technology has evolved in four main phases over the years (Pre-train, Prompt, and Predict: A Systematic Survey of Prompting Methods in Natural Language Processing, Pengfei Liu, et al., 2021). The first phase is feature engineering, which is based on probability models and rules using labeled data. After that, with the revival of deep learning network technology due to advances in semiconductor computing technology, deep learning networks were introduced, but the era of architecture engineering began on the basis of supervised learning using labeled data. At the time, the goal of research was to learn how to construct a deep learning network that is effective for natural language processing. In 2017, natural language processing technology underwent a sharp inflection point because large pre-trained language models based on unsupervised learning and fine-tuning methods employing the models began to show high performance in most natural language processing tasks. From this point on, large language models based on transformers, such as generative pre-trained transformers (GPTs) and bidirectional encoder representations from transformers (BERTs), were published one after another, and a paradigm (objective engineering) was established that processes most tasks by fine-tuning large pre-trained models according to goals.

Large pre-trained language models learn a large number of sentences collected and refined from the web and the like in an auto-regressive manner and have been developed by large information technology (IT) companies, research organizations, and the like due to their high cost of training. In other words, it is very expensive and inefficient for an individual researcher to fine-tune a large pre-trained model for a specific task. For this reason, a task processing method employing a prompt was introduced to GPT-2 and the following series, which utilizes a large pre-trained model for few-shot or zero-shot learning by “presenting a problem to be solved in the form of a predefined sentence.” For example, when a task is to translate Korean to English, existing objective engineering solves the task through additional fine-tuning using pairs of a Korean sentence and a translated English sentence. However, prompt learning solves a problem by presenting the prompt “Translate from Korean to English” and some example sentences to limit the output of a large pre-trained language model so that the pre-trained language model produces a result sentence specific to a current task.

A current trend in natural language processing research is to imagine a large pre-trained model as a black box and aim to construct an appropriate prompt for a task, which is referred to as prompt engineering. Lately, continuous prompting, whereby prompts are presented as vectors (or embeddings), has been proposed instead of discrete prompting whereby prompts are presented in natural language, and it has become possible to numerically analyze prompts. Accordingly, studies and the like are being published that incorporate the metric-based approach such as generating prompts on the basis of similarities between tasks.

### 3. Problems in Meta-Learning and Meta-Reinforcement Learning

Meta-learning and meta-reinforcement learning aim to quickly adapt to new tasks not encountered during the training phase and thus have aimed to find a learning point that is neutral in terms of performance for a variety of tasks while avoiding overfitting to a particular task as much as possible. In other words, it is necessary to simultaneously solve two problems of improving generalization performance as high as possible and rapidly adapting to new tasks. Since these two objects generally conflict with each other, current meta-learning and meta-reinforcement learning inevitably suffer from a reduced scope of tasks.

### RELATED ART DOCUMENTS

### Non-Patent Documents

(Non-Patent Document 1) C. Finn, P. Abbeel, and S. Levine. “Model-agnostic metalearning for fast adaptation of deep networks.” In International Conference on Machine Learning, 2017. arXiv:1703.03400 available at https://arxiv.org/abs/1703.03400
(Non-Patent Document 2) Pengfei Liu, Weizhe Yuan, Jinlan Fu, Zhengbao Jiang, Hiroaki Hayashi, Graham Neubig. “Pre-train, Prompt, and Predict: A Systematic Survey of Prompting Methods in Natural Language Processing.” 2021. arXiv:2107.13586 available at https://arxiv.org/abs/2107.13586

### SUMMARY OF THE INVENTION

The present invention is directed to providing a prompt-based meta-learning method that assists a large pre-trained model, in which a prompt is required to maintain generalization performance, to rapidly adapt to each task in order to change a fine-tuning paradigm that existing pre-trained models have and expand the range of tasks processible by a pre-trained model.

Objects of the present invention are not limited to that described above, and other objects which have not been described will be clearly understood by those of ordinary skill in the art from the following description.

According to an aspect of the present invention, there is provided an inference method employing a prompt-based meta-learning network, the inference method including selecting a task, inputting the selected task to a prompt-embedding network (PEN) to generate a prompt key for the selected task, calculating similarities between the prompt key for the selected task and prompt keys included in a prompt key pool (PKP) using a similarity function, acquiring a prompt value for the selected task using a memory network (MN) on the basis of the similarities and the prompt keys included in the PKP, and generating an inference result for the selected task using a model-agnostic meta-learning (MAML)-based pre-trained model (MPM) on the basis of the selected task and the prompt value for the selected task.

The PKP may be a set of prompt keys for tasks used for training the PEN, the MN, and the MPM.

The MN may be trained under supervised learning using prompt keys for tasks and prompt values for the tasks as inputs and labels, respectively.

The MPM may be trained according to an MAML methodology on the basis of tasks which are randomly selected from a task distribution.

The PEN may be trained through end-to-end learning of a prompt-based meta-learning network including the PEN, the trained MN, and the trained MPM.

The selecting of the task may include selecting a task from a task distribution corresponding to any one of a discrete probability distribution and a continuous probability distribution.

The generating of the inference result may include generating an embedding vector on the basis of the selected task and the prompt value for the selected task and inputting the embedding vector to the MPM to generate the inference result.

The generating of the inference result may include concatenating the selected task and the prompt value for the selected task to generate the embedding vector.

The similarity function may include any one of a cosine similarity and an attention.

The acquiring of the prompt value may include inputting a prompt key having a highest similarity with the prompt key of the selected task among the prompt keys included in the PKP to the MN to acquire the prompt value for the selected task.

According to another aspect of the present invention, there is provided a computer system including a memory configured to store computer-readable instructions and at least one processor configured to execute the instructions.

The at least one processor may execute the instructions to select a task from a task distribution according to a setting, generate a prompt key for the selected task by inputting the selected task to a PEN, calculate similarities between the prompt key for the selected task and prompt keys included in a PKP using a similarity function, acquire a prompt value for the selected task using an MN on the basis of the similarities and the prompt keys included in the PKP, and generate an inference result for the selected task using an MPM on the basis of the selected task and the prompt value for the selected task.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating a general configuration of meta-learning;

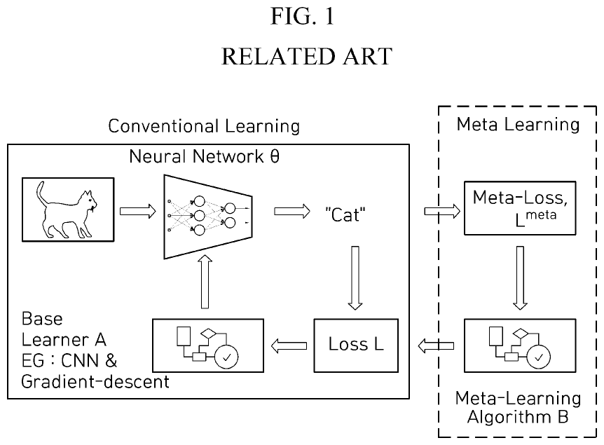

FIG. 2 is a diagram illustrating a configuration of prompt-based meta-learning according to the present invention;

FIG. 3 is a diagram illustrating a configuration of prompt-based meta-reinforcement learning according to the present invention;

FIG. 4 is a flowchart illustrating an inference method employing a prompt-based meta-learning network according to an exemplary embodiment of the present invention; and

FIG. 5 is a block diagram of a computer system for implementing a prompt-based meta-learning method and an inference method employing a prompt-based meta-learning network according to an exemplary embodiment of the present invention.

### DETAILED DESCRIPTION OF EXEMPLARY EMBODIMENTS

The present invention relates to a prompt-based meta-learning method in which prompts are introduced to meta-learning. The specification proposes a prompt-based meta-learning method that allows an increase in the speed of adapting to new tasks and an expansion of the range of processible tasks while generalization performance is maintained.

Advantages and features of the present invention and methods of achieving them will become clear with reference to exemplary embodiments described below in detail in conjunction with the accompanying drawings. However, the present invention is not limited to the embodiments disclosed below and may be implemented in various different forms. The embodiments are provided only to make the disclosure of the present invention complete and fully convey the scope of the present invention to those skilled in the technical field to which the present invention pertains, and the present invention is only defined by the scope of the claims. Terminology used herein is for describing the embodiments and is not intended to limit the present invention. In this specification, singular forms also include plural forms unless specifically stated otherwise. As used herein, “comprises” and/or “comprising” specify the presence of constituent elements, steps, operations, and/or devices but do not preclude the presence or addition of one or more other constituent elements, steps, operations, and/or devices.

When a first component is referred to as “connected” or “coupled” to a second component, the first component may be directly connected or coupled to the second component, or a third component may be interposed therebetween. On the other hand, when a first component is referred to as “directly connected” or “directly coupled” to a second component, there is no third component therebetween. Other expressions describing the relationship between components, such as “between” and “just between,” “adjacent to” and “directly adjacent to,” and the like, should be interpreted in the same manner.

In describing the present invention, when it is determined that detailed description of related well-known technology will unnecessarily obscure the gist of the present invention, the detailed description will be omitted.

Hereinafter, exemplary embodiments of the present invention will be described in detail with reference to the accompanying drawings. In describing the present invention, to facilitate overall understanding, the same reference numeral will be used for the same element throughout the drawings.

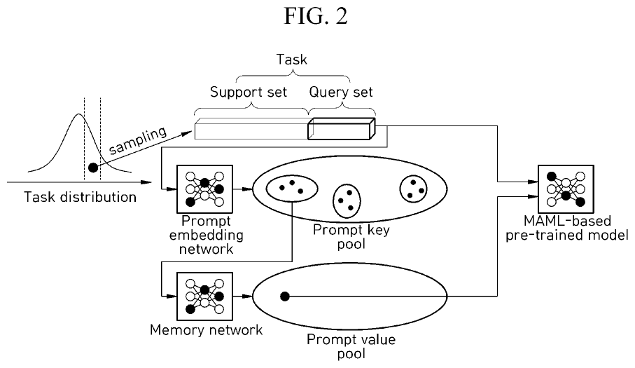

FIG. 2 is a diagram illustrating a configuration of prompt-based meta-learning according to the present invention.

A prompt-based meta-learning network according to an exemplary embodiment of the present invention includes a prompt-embedding network (PEN), a memory network (MN), and a model-agnostic meta-learning (MAML)-based pre-trained model (MPM). The prompt-based meta-learning network is configured to sample a task including a support set and a query set from a task distribution, generate and add a prompt key to a prompt key pool (PKP) when the task is input to the PEN, generate and add a prompt value to a prompt value pool (PVP) when the prompt key extracted from the PKP is input to the MN, and generate an inference result for the sampled task by inputting the task and the prompt value to the MPM.

An inference process of a prompt-based meta-learning network according to an exemplary embodiment of the present invention will be described below. For convenience of description, it is assumed that the inference process of the prompt-based meta-learning network is performed by a processor 1010 of a computer system 1000 that performs a prompt-based meta-learning method according to an exemplary embodiment of the present invention (hereinafter, “computer system”).

The processor 1010 selects a new task T_{M+1} from a task distribution T. The task distribution T may be any one of a discrete probability distribution and a continuous probability distribution. The processor 1010 may select the new task T_{M+1} from the task distribution T according to a user's input or a setting. In this case, the new task T_{M+1} may be selected randomly or on the basis of a problem to be solved (specified according to the user's input or the setting).

As shown in Equation 1, the task distribution T may include a plurality of discrete tasks.

$$T = \{ {T}_{1} , {T}_{2} , {T}_{3} , ... {T}_{N} \} \qquad [ Equation 1 ]$$

Each task belonging to the task distribution T includes a support set and a query set.

The processor 1010 selects the new task T_{M+1} from the task distribution T. As shown in Equation 2, the task T_{M+1} belonging to the task distribution T includes a support set S_{M+1} and a query set Q_{M+1}.

$${T}_{M + 1} = \{ {S}_{M + 1} , {Q}_{M + 1} \} \qquad [ Equation 2 ]$$

The PEN is a network that receives a task and outputs a prompt embedding (also referred to as a “prompt key”). The prompt embedding (prompt key) may be represented as a vector.

The processor 1010 transcribes the selected task T_{M+1} to a prompt key x_{M+1} through the PEN. In other words, the processor 1010 generates the prompt key x_{M+1} by inputting the selected task T_{M+1} to the PEN. This may be represented as shown in Equation 3.

$${x}_{M + 1} = PEN ( {T}_{M + 1} ) \qquad [ Equation 3 ]$$

A prompt key for a task is stored in the PKP. Prompt keys of previously learned tasks are stored in the PKP. In other words, the PKP is a set of prompt keys for tasks used for training the prompt-based meta-learning network including the PEN, the MN, and the MPM.

The processor 1010 stores the prompt key obtained from an output of the PEN in the PKP.

The PKP K may be represented as shown in Equation 4. The PKP K of Equation 4 is a PKP before the prompt key for the new task T_{M+1} is added.

$$K = \{ {K}_{1} , {K}_{2} , {K}_{3} , ... {K}_{M} \} \qquad [ Equation 4 ]$$

The processor 1010 calculates a similarity between the PEN result x_{M+1} of the new task T_{M+1} and each previously learned task prompt key Kₘ stored in the PKP. In other words, the processor 1010 calculates a similarity between the prompt key x_{M+1} for the new task T_{M+1} and each existing prompt key Kₘ in the PKP using a similarity function PKSIM. The similarity function PKSIM may include any one of a cosine similarity and an attention.

The processor 1010 inputs the prompt key x_{M+1} for the new task T_{M+1} and each prompt key Kₘ in the PKP to the similarity function PKSIM and calculates a final similarity with each prompt key Kₘ in the PKP through a softmax operation on the basis of the result of the similarity function PKSIM.

The processor 1010 calculates a final similarity sₘ between any prompt key Kₘ in the PKP and the prompt key x_{M+1} for the selected task T_{M+1} as shown in Equation 5.

$${s}_{m} = softmax ( PKSIM ( {K}_{m} , {x}_{M + 1} ) ) \qquad [ Equation 5 ]$$

The processor 1010 adds the prompt key x_{M+1} for the selected task T_{M+1} to the PKP for utilization in a next task. Therefore, the new prompt key K_{M+1} in the PKP becomes the prompt key x_{M+1} for the selected task T_{M+1} as shown in Equation 6.

$${K}_{M + 1} = {x}_{M + 1} \qquad [ Equation 6 ]$$

The PKP to which the new prompt key K_{M+1} is added is represented as shown in Equation 7.

$$K = \{ {K}_{1} , {K}_{2} , {K}_{3} , ... {K}_{M} , {K}_{M + 1} \} \qquad [ Equation 7 ]$$

The prompt-based meta-learning network according to the present invention performs an inference process to reflect on the prompt value for the new task using the MPM. Therefore, a process is necessary to acquire (or set) the prompt value for the new task on the basis of the new prompt key and a prompt value pool (PVP) V using the MN.

The PVP V storing prompt values corresponding to the prompt keys of the previously learned tasks may be represented as shown in Equation 8. In other words, the PVP V may be a set of the prompt values for the previously learned tasks. Specifically, the PVP V is a set of prompt values for tasks used for training the prompt-based meta-learning network including the PEN, the MN, and the MPM.

$$V = \{ {V}_{1} , {V}_{2} , {V}_{3} , ... {V}_{M} \} \qquad [ Equation 8 ]$$

Meanwhile, the MN is a network that outputs a prompt value corresponding to an input prompt key.

There are a variety of ways to acquire a prompt value for a new task using the MN. Depending on the application field of the present invention, a method of acquiring a prompt value may vary.

As an example, the processor 1010 may acquire a prompt value V_{M+1} for the selected task T_{M+1} by inputting a prompt key having the highest similarity with the prompt key K_{M+1} of the selected task T_{M+1} among prompt keys included in the PKP (see Equation 8) to the MN. In other words, when the MN receives the prompt key having the highest similarity with the prompt key K_{M+1} of the selected task T_{M+1}, the MN may extract a prompt value corresponding to the prompt key from the PVP V, and the processor 1010 may set the prompt value as the prompt value V_{M+1} for the selected task T_{M+1}. The above description is represented as shown in Equation 9.

$${V}_{M + 1} = MN ( {arg max}_{{K}_{m}} ( softmax ( PKSIM ( {K}_{m} , {K}_{M + 1} ) ) ) ) \qquad [ Equation 9 ]$$

As another example, the processor 1010 may select a certain number of prompt keys from the PKP in decreasing order of the final similarity sₘ or multiple prompt keys having the final similarity sₘ of a reference value or more. In this case, the processor 1010 may calculate a weight for each prompt key on the basis of the final similarity sₘ, acquire a plurality of prompt values by inputting the prompt keys to the MN, and then set the sum of the weights of the plurality of prompt values as the new prompt value V_{M+1}.

As still another example, as shown in Equation 10, the processor 1010 may determine the sum of weights of all prompt values belonging to the PVP V of Equation 8 as the new prompt value V_{M+1} using the final similarity sₘ as a weight. For reference, since the sum of softmax output values is 1, the sum of the final similarities sₘ of all the prompt keys is 1.

$${V}_{M + 1} = {\sum }_{m = 1}^{M} {s}_{m} {V}_{m} \qquad [ Equation 10 ]$$

A prompt value Vₘ corresponding to a prompt embedding key of a previously learned task is stored in the PVP V. The PVP V which is updated by adding the new prompt value V_{M+1} is represented as shown in Equation 11.

$$V = \{ {V}_{1} , {V}_{2} , {V}_{3} , ... {V}_{M} , {V}_{M + 1} \} \qquad [ Equation 11 ]$$

The processor 1010 calculates the prompt value V_{M+1} corresponding to the current task T_{M+1} through the foregoing process and then adds the prompt value V_{M+1} to the PVP V for utilization in a next task.

The processor 1010 generates an embedding to be input to the MPM on the basis of the selected task T_{M+1} and the prompt value V_{M+1}. For example, the processor 1010 generates an input embedding for the MPM by concatenating the selected task T_{M+1} and the prompt value V_{M+1}.

The MPM derives an inference result y_{M+1} for the selected task T_{M+1} from the selected task T_{M+1} and the prompt value V_{M+1} as shown in Equation 12.

$${y}_{M + 1} = MPM ( {V}_{M + 1} , {T}_{M + 1} ) \qquad [ Equation 12 ]$$

In other words, the processor 1010 generates the inference result y_{M+1} for the selected task T_{M+1} on the basis of the selected task T_{M+1} and the prompt value V_{M+1} using the MPM.

Specifically, the processor 1010 generates an input embedding on the basis of the selected task T_{M+1} and the prompt value V_{M+1} and generates the inference result y_{M+1} by inputting the input embedding to the MPM. For example, the processor 1010 generates the input embedding by concatenating the selected task T_{M+1} and the prompt value V_{M+1} and generates the inference result y_{M+1} by inputting the input embedding to the MPM.

While existing deep learning networks use only tasks as inputs, the present invention uses an MPM on the basis of task information and a prompt value for the task to make an inference and thus can use the information of solving similar tasks in the past. In other words, since the present invention adapts an MPM to new tasks at a faster rate by incorporating generated prompt values into inferences, it is possible to have the same effect as fine-tuning the MPM.

As described above, the prompt-based meta-learning network according to the exemplary embodiment of the present invention includes three deep learning networks (the PEN, the MN, and the MPM). The learning process of the three deep learning networks included in the prompt-based meta-learning network according to the exemplary embodiment of the present invention will be described below.

First, the MPM is trained by randomly selecting multiple tasks from the task distribution T and then maximizing generalization performance on the basis of the randomly selected tasks according to an MAML training methodology. The MPM may be configured in various multi-layer perceptron (MLP) schemes according to tasks. For example, the MPM may be configured as a convolutional neural network (CNN) for image segmentation tasks, an actor-critic model for reinforcement learning tasks, or a recurrent neural network (RNN), a transformer, or the like for natural language processing tasks.

Since the MAML training methodology is a well-known methodology, the detailed description of an MPM training process will be omitted.

The MN may be configured as an attention-based network, which is trained under supervised learning using pairs of a prompt key and a prompt value. In other words, the MN may be trained using the PKP of the previously learned tasks and pairs of the prompt key of each task and the prompt value extracted from the PVP. In this case, the prompt keys are inputs for the MN, and the prompt values are labels. When a prompt key is input, the trained MN outputs a prompt value.

The PEN may be configured as a simple MLP. It is necessary to set a loss function to train the PEN. The PEN is trained through end-to-end learning using the trained MPM and the trained MN. In other words, after the MPM and the MN separately finish learning, the prompt-based meta-learning network is configured with the PEN, the trained MPM, and the trained MN. Then, the PEN may be trained through end-to-end learning.

In training the PEN, metric learning may be used to place prompt keys of tasks with high similarity in a vector space close together and place prompt keys of tasks with low similarity away from each other.

Since the PEN places prompts key vectors according to similarities between tasks, contrastive learning may be applied to training of the PEN.

An inference process and a learning process of a prompt-based meta-learning network according to the present invention have been described above with reference to FIG. 2. A part of the learning process of the prompt-based meta-learning network according to the present invention may be changed to perform meta-reinforcement learning and inference.

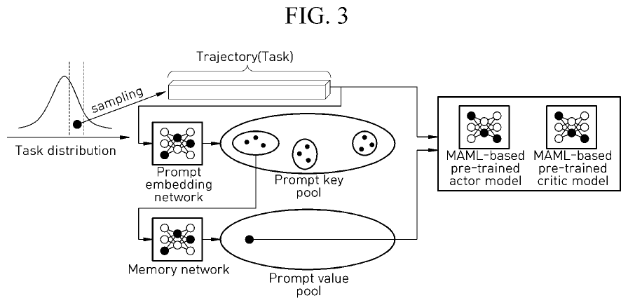

FIG. 3 is a diagram illustrating a configuration of prompt-based meta-reinforcement learning according to the present invention. The prompt-based meta-reinforcement learning of FIG. 3 may be an application of the prompt-based meta-learning described above with reference to FIG. 2. Therefore, an inference process and a learning process of the prompt-based meta-reinforcement learning are the same as the prompt-based meta-learning described above. However, tasks in the prompt-based meta-reinforcement learning according to the present invention and compositional features of an MPM will be described below.

In the case of prompt-based meta-reinforcement learning according to the present invention, tasks are likewise sampled from a task distribution. Tasks sampled from a task distribution are trajectories Tₙ which are sets of transition tuples tₗ. Here, transition tuples include a state, an action, a reward, and a transition probability.

FIG. 13 shows that the trajectories Tₙ are sets of transition tuples, and FIG. 14 shows a case where the transition tuples tₗ include a state si, an action aₗ, a reward rₗ, and a transition probability pₗ.

$${T}_{n} = \{ {t}_{1} , {t}_{2} , {t}_{3} , ... {t}_{L} \} \qquad [ Equation 13 ]$$

$${t}_{l} = ( {s}_{l} , {a}_{l} , {r}_{l} , {p}_{l} ) \qquad [ Equation 14 ]$$

In prompt-based meta-reinforcement learning according to the present invention, an MPM is divided into an actor network and a critic network for reinforcement learning. For reference, an actor-critic network is a method frequently used in reinforcement learning, in which a network (actor) for determining an action and a network (critic) for determining the value of a state are separately configured. Only actors or critics had been used until an actor-critic network was proposed. However, since the integrated network was proposed, the performance of reinforcement learning has been developed.

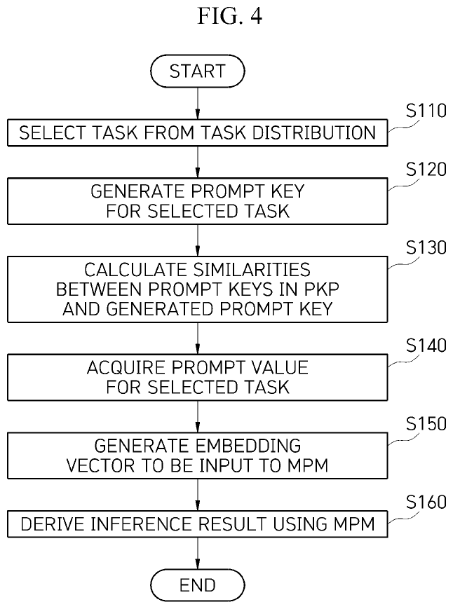

FIG. 4 is a flowchart illustrating an inference method employing a prompt-based meta-learning network according to an exemplary embodiment of the present invention. For convenience of description, it is assumed that the inference method is performed by the processor 1010 of the computer system 1000 that performs a prompt-based meta-learning method according to an exemplary embodiment of the present invention.

Operation S110 is a task selection operation.

The processor 1010 selects a new task T_{M+1} from a task distribution T. The task distribution T may be any one of a discrete probability distribution and a continuous probability distribution. The processor 1010 may select the new task T_{M+1} from the task distribution T according to a user's input or a setting. In this case, the new task T_{M+1} may be selected randomly or on the basis of a problem to be solved (specified according to the user's input or the setting). As shown in Equation 1, the task distribution T may include a plurality of discrete tasks (see Equation 1).

Operation S120 is a prompt key generation operation.

The processor 1010 generates a prompt key x_{M+1} by inputting the selected task T_{M+1} to a PEN (see Equation 3).

Operation S130 is an operation of calculating a similarity between prompt keys.

The processor 1010 calculates a similarity between each prompt key stored in a PKP and the prompt key x_{M+1} of the selected task T_{M+1}. The PKP is a set of prompt keys Kₘ for previously learned tasks (see Equation 4). The processor 1010 may use a cosine similarity, an attention, or the like as a similarity function PKSIM.

The processor 1010 may input the prompt key x_{M+1} for the selected task T_{M+1} and each prompt key Kₘ in the PKP to the similarity function PKSIM and calculate a similarity between each prompt key Kₘ in the PKP and the prompt key x_{M+1} for the selected task T_{M+1} through a softmax operation on the basis of the result of the similarity function PKSIM (see Equation 5).

The processor 1010 adds the prompt key x_{M+1} for the selected task T_{M+1} to the PKP. In other words, the prompt key x_{M+1} for the selected task T_{M+1} becomes a new prompt key K_{M+1} in the PKP (see Equations 6 and 7).

Operation S140 is an operation of acquiring a prompt value for the selected task. The processor 1010 acquires a prompt value V_{M+1} for the selected task T_{M+1} using an MN on the basis of the similarities calculated in operation S130 and the prompt keys included in the PKP.

The processor 1010 may acquire the prompt value V_{M+1} in a variety of ways. As described above, the processor 1010 may acquire the prompt value V_{M+1} for the selected task T_{M+1} (see Equation 9) by inputting a prompt key having the highest similarity with the prompt key K_{M+1} of the selected task T_{M+1} among the prompt keys included in the PKP (see Equation 8) to the MN.

As another example, the processor 1010 may select a certain number of prompt keys from the PKP in decreasing order of the final similarity sₘ or multiple prompt keys having the final similarity sₘ of a reference value or more. In this case, the processor 1010 may calculate a weight for each prompt key on the basis of the final similarity sₘ, acquire a plurality of prompt values by inputting the prompt keys to the MN, and then set the sum of the weights of the plurality of prompt values as the new prompt value V_{M+1}.

As still another example, the processor 1010 may determine the sum of weights of all prompt values belonging to the PVP V of Equation 8 as the new prompt value V_{M+1} using the final similarity sₘ as a weight (see Equation 10).

Then, the processor 1010 adds the newly acquired prompt value V_{M+1} to the PVP V (see Equation 11).

Operation S150 is an operation of generating an embedding vector to be input to an MPM.

The processor 1010 generates an embedding vector to be input to the MPM on the basis of the selected task T_{M+1} and the prompt value V_{M+1} (see Equation 12). For example, the processor 1010 generates an embedding vector to be input to the MPM by concatenating the selected task T_{M+1} and the prompt value V_{M+1}.

Operation S160 is an operation of deriving an inference result using the MPM.

The processor 1010 generates an inference result y_{M+1} for the selected task T_{M+1} by inputting the embedding vector, which is generated on the basis of the selected task T_{M+1} and the prompt value V_{M+1}, to the MPM.

The foregoing inference method employing a prompt-based meta-learning network has been described with reference to the flowchart shown in the drawing. For simplicity of description, the method has been illustrated as a series of blocks, but the present invention is not limited to the order of blocks. Some blocks may be performed in a different order from that illustrated herein or performed at the same time as other blocks, and many different branches, flow paths, and sequences of blocks may be implemented that achieve the same or similar results. Also, not all the illustrated blocks may be required for implementing the method described herein.

In the description of FIG. 4, according to implementation of the present invention, each operation may be subdivided into additional operations, or the operations may be combined into fewer operations. As necessary, some operations may be omitted, and the sequence of operations may be changed. Also, the descriptions of FIGS. 2 and 3 may be applied to FIG. 4 even when the description is omitted. The description of FIG. 4 may likewise be applied to the descriptions of FIGS. 2 and 3.

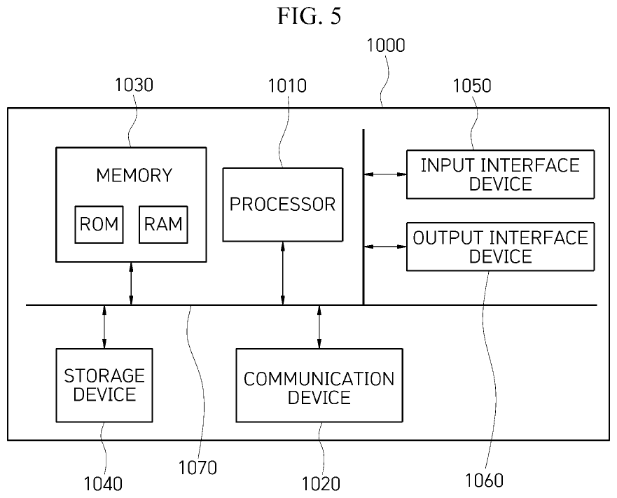

FIG. 5 is a block diagram of a computer system for implementing a prompt-based meta-learning method and an inference method employing a prompt-based meta-learning network according to an exemplary embodiment of the present invention.

The computer system of FIG. 5 may be applied to not only the meta-learning method and the inference method according to the meta-learning configuration of FIG. 2 but also the meta-reinforcement learning method and the inference method according to the meta-reinforcement learning configuration of FIG. 3. The computer system of FIG. 5 may perform the inference method employing a prompt-based meta-learning network according to the exemplary embodiment of the present invention illustrated in FIG. 4.

Referring to FIG. 5, the computer system 1000 may further include at least one among one or more processors 1010, a memory 1030, an input interface device 1050, an output interface device 1060, and a storage device 1040 which perform communication through a bus 1070. The computer system 1000 may further include a communication device 1020 combined with a network.

The processor 1010 executes instructions stored in the memory 1030 or the storage device 1040. The processor 1010 may be a central processing unit (CPU) or semiconductor device. The processor 1010 may train a prompt-based meta-learning network according to the present invention and perform an inference method employing a prompt-based meta-learning network according to the present invention.

The processor 1010 selects a task from a task distribution according to a setting by executing an instruction stored in the memory 1030 or the storage device 1040, generates a prompt key for the selected task by inputting the selected task to a PEN, calculates similarities between the prompt key for the selected task and prompt keys included in a PKP using a similarity function which includes any one of a cosine similarity and an attention, acquires a prompt value for the selected task using an MN on the basis of the similarities and the prompt keys included in the PKP, and generates an inference result for the selected task using an MPM on the basis of the selected task and the prompt value for the selected task.

The PKP may be a set of prompt keys for tasks used for training the PEN, the MN, and the MPM.

The processor 1010 may generate an embedding vector on the basis of the selected task and the prompt value for the selected task and generate the inference result by inputting the embedding vector to the MPM. Here, the processor 1010 may generate the embedding vector by concatenating the selected task and the prompt value for the selected task.

The processor 1010 may acquire the prompt key for the selected task by inputting a prompt key having the highest similarity with the prompt key of the selected task among prompt keys included in the PKP to the MN.

Details of functions of the processor 1010 may be understood with reference to the descriptions of FIGS. 2 to 4. In other words, descriptions of FIGS. 2 to 4 may be included in the functions of the processor 1010 included in the computer system 1000 shown in FIG. 5.

The memory 1030 and the storage device 1040 store computer-readable instructions. The memory 1030 and the storage device 1040 may include various forms of volatile or non-volatile storage media. For example, the memory may include a read-only memory (ROM) and a random-access memory (RAM). According to embodiments of the present disclosure, the memory 1030 may be present in or out of the processor and connected to the processor through various well-known devices. The memory is one of various forms of volatile or non-volatile storage media. For example, the memory may include a ROM or RAM.

Therefore, an exemplary embodiment of the present invention may be implemented as a method by a computer or as a non-transitory computer-readable medium in which computer-executable instructions are stored. In an exemplary embodiment, when executed by the processor, the computer-readable instructions may perform a method according to at least one aspect of the present disclosure.

The communication device 1020 may transmit or receive a wired signal or wireless signal.

Also, a method according to an embodiment of the present invention may be implemented in the form of program instructions that are executable by various computing devices and recorded on a computer-readable medium.

The computer-readable medium may include program instructions, data files, data structures, and the like solely or in combination. The program instructions recorded on the computer-readable medium may be specially designed and prepared for embodiments of the present invention or may be available well-known instructions for those skilled in the field of computer software. The computer-readable medium may include a hardware device configured to store and execute the program instructions. Examples of the computer-readable medium may be magnetic media, such as a hard disk, a floppy disk, and magnetic tape, optical media, such as a compact disc ROM (CD-ROM) and a digital versatile disc (DVD), magneto-optical media, such as a floptical disk, and hardware devices such as a ROM, a RAM, a flash memory, and the like. Examples of the program instructions include machine code generated by a compiler and high-level language code that are executable by a computer using an interpreter and the like.

According to an exemplary embodiment of the present invention, it is possible to speed up adaptation to new tasks by applying prompts containing information on tasks to meta-learning or meta-reinforcement learning. Also, it is possible to broaden the range of tasks that can be processed by meta-learning or meta-reinforcement learning.

Effects of the present invention are not limited to those described above, and other effects which have not been described above will be clearly understood by those skilled in the technical field to which the present invention pertains from the above description.

Although exemplary embodiments of the present invention have been described above, those skilled in the art will understand that various modifications and alterations can be made without departing from the spirit and scope of the present invention stated in the following claims.

What is claimed is:

1. An inference method employing a prompt-based meta-learning network, the inference method comprising:
selecting a task;
inputting the selected task to a prompt-embedding network (PEN) to generate a prompt key for the selected task;
calculating similarities between the prompt key for the selected task and prompt keys included in a prompt key pool (PKP) using a similarity function;
acquiring a prompt value for the selected task using a memory network (MN) on the basis of the similarities and the prompt keys included in the PKP; and
generating an inference result for the selected task using a model-agnostic meta-learning (MAML)-based pre-trained model (MPM) on the basis of the selected task and the prompt value for the selected task.

2. The inference method of claim 1, wherein the PKP is a set of prompt keys for tasks used for training the PEN, the MN, and the MPM.

3. The inference method of claim 1, wherein the MN is trained under supervised learning using prompt keys for tasks and prompt values for the tasks as inputs and labels, respectively.

4. The inference method of claim 1, wherein the MPM is trained according to an MAML methodology on the basis of tasks which are randomly selected from a task distribution.

5. The inference method of claim 1, wherein the PEN is trained through end-to-end learning of a prompt-based meta-learning network including the PEN, the trained MN, and the trained MPM.

6. The inference method of claim 1, wherein the selecting of the task comprises selecting a task from a task distribution corresponding to any one of a discrete probability distribution and a continuous probability distribution.

7. The inference method of claim 1, wherein the generating of the inference result comprises generating an embedding vector on the basis of the selected task and the prompt value for the selected task and inputting the embedding vector to the MPM to generate the inference result.

8. The inference method of claim 7, wherein the generating of the inference result comprises concatenating the selected task and the prompt value for the selected task to generate the embedding vector.

9. The inference method of claim 1, wherein the similarity function includes any one of a cosine similarity and an attention.

10. The inference method of claim 1, wherein the acquiring of the prompt value comprises inputting a prompt key having a highest similarity with the prompt key of the selected task among the prompt keys included in the PKP to the MN to acquire the prompt value for the selected task.

11. A computer system comprising:
a memory configured to store computer-readable instructions; and
at least one processor configured to execute the instructions,
wherein the at least one processor executes the instructions to select a task from a task distribution according to a setting, generate a prompt key for the selected task by inputting the selected task to a prompt embedding network (PEN), calculate similarities between the prompt key for the selected task and prompt keys included in a prompt key pool (PKP) using a similarity function, acquire a prompt value for the selected task using a memory network (MN) on the basis of the similarities and the prompt keys included in the PKP, and generate an inference result for the selected task using a model-agnostic meta-learning (MAML)-based pre-trained model (MPM) on the basis of the selected task and the prompt value for the selected task.

12. The computer system of claim 11, wherein the PKP is a set of prompt keys for tasks used for training the PEN, the MN, and the MPM.

13. The computer system of claim 11, wherein the at least one processor generates an embedding vector on the basis of the selected task and the prompt value for the selected task and generates the inference result by inputting the embedding vector to the MPM.

14. The computer system of claim 13, wherein the at least one processor generates the embedding vector by concatenating the selected task and the prompt value for the selected task.

15. The computer system of claim 11, wherein the similarity function includes any one of a cosine similarity and an attention.

16. The computer system of claim 11, wherein the at least one processor acquires the prompt value for the selected task by inputting a prompt key having a highest similarity with the prompt key of the selected task among the prompt keys included in the PKP to the MN.
